(19) United States
(12) Patent Application Publication
(10) Pub. No.: US 2009/0222880 A1
(43) Pub. Date: Sep. 3, 2009

(54) Configurable access control security for virtualization

(75) Inventors: Frank L. Mayer, Ellicott City, MD (US); James L. Athey, Washington, DC (US); Kenneth M. Walker, Severna Park, MD (US); Spencer R. Shimko, Halethrope, MD (US); Charles D. Sellers, Columbia, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Tresys Technology, LLC, Columbia, MD (US)

(21) Appl. No.: 12/073,252

(22) Filed: Mar. 3, 2008

(51) Int. Cl. G06F 21/00; G06F 9/455

(52) U.S. Cl. 726/1; 718/1

(57) ABSTRACT

Provided are systems and methods for applying access controls to separate and contain virtual machines in a flexible, configurable manner. Access can be granted or removed to a variety of system resources—including network cards, shared folders, and external devices. Operations, such as cut and paste, between the virtual machines can be restricted or allowed. Virtual machines are run in containers. This allows more than one virtual machine to share the same access profile. Containers can be configured to allow a user to instantiate a virtual machine at run time. This allows the user to dynamically define which virtual machines run in various containers. An administrator determines which containers (if any) allow dynamic instantiation, and specifies the list of virtual machines the user can choose from. A container, and/or virtual machines within the container, can be restricted to particular users.

### FIELD OF THE INVENTION

The present invention is generally directed to computer security. More particularly, it is directed to implementing access control in a computer, and applications thereof.

### BACKGROUND OF THE INVENTION

A virtual machine (VM) is a software implementation that executes on a host computer. Virtualization (e.g., the use of one or more virtual machines) is being widely implemented, but contains inherent weaknesses. Many vulnerabilities have been discovered and exploited that allow an attacker to gain unexpected access to the host operating system from a virtual machine. To reduce these vulnerabilities, a security mechanism—commonly referred to as access control—has been used. There are two main types of access control: discretionary access control (DAC) and mandatory access control (MAC).

Under DAC, system resources have security attributes (e.g., passwords and/or access control lists) associated with them. Access to system resources is controlled based on these security attributes, which are used to protect the system resources (e.g., files) owned by one user from unauthorized access by other users. A weakness associated with DAC is that the security attributes assigned to each system resource are specified by the resource owner and can be modified or removed at will. During a computer attack, an attacker may be able to alter DAC security attributes and thereby gain access to any or all system resources. Not surprisingly, existing virtualization systems that rely on DAC have demonstrated security vulnerabilities.

Under MAC, access to system resources is controlled by security attributes that cannot be modified or removed during normal operation. In this way, MAC offers a greater level of security compared to DAC.

An example of MAC is type enforcement. Type enforcement is implemented, for example, in security-enhanced Linux (SELinux). In type enforcement, both applications and system resources are assigned a type. Access for a type enforcement system such as SELinux is defined by a collection of rules contained in a file called a policy. A policy file is loaded into the operating system kernel of a machine during the boot process. The type attributes assigned to applications and system resources cannot be changed during normal operation.

Although MAC such as type enforcement provides a greater level of security than DAC, configuring the policy is difficult. The policy language of SELinux, for example, includes many complexities that must be well understood by a system developer before the system developer can create an effective security-enhanced system. Many system developers, however, do not have such an understanding. Therefore, many system developers cannot take advantage of the enhanced security offered by MAC to provide secure and configurable resource sharing in virtualization systems.

What are needed are new techniques and tools for implementing access control that overcome the deficiencies noted above.

### BRIEF SUMMARY OF THE INVENTION

The present invention provides systems and methods for configurable access control for virtualization, and applications thereof. In an embodiment, the present invention provides a system that includes a container, a security policy, and a loader. The container is configured to contain one or more virtual machines. The security policy controls access to the container. The loader loads a first virtual machine image into the container based on the access granted by the security policy.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a diagram illustrating an example system having a configurable MAC security policy for virtualization.

FIG. 2 is a diagram illustrating example operation of a configurable MAC security policy for virtualization.

FIG. 3 is a diagram illustrating an example loader for reconfiguring a virtual machine image to correspond to a configured MAC security policy.

FIG. 4 is a screenshot of an example graphical user interface that may be used to provide security configuration information.

FIG. 5 is a diagram illustrating an embodiment of a system generation module for generating an installation package to provide a MAC security policy for virtualization.

FIG. 6 is a screenshot of an example graphical user interface that may be used to generate the installation package of FIG. 4.

FIG. 7 is a screenshot of an example graphical user interface for monitoring a MAC security policy installed using the installation package of FIG. 4.

FIG. 8 is a diagram illustrating another embodiment of the system generation module for reconfiguring a security policy.

FIG. 9 is a diagram illustrating the example system of FIG. 1 having a reconfigured MAC security policy.

FIGS. 10A and 10B are screenshots of example graphical user interfaces that may be used to provide security configuration information.

FIG. 11 is a screenshot of an example graphical user interface illustrating changes to a MAC security policy based on the changes to the security configuration illustrated in FIGS. 10A and 10B.

The features and advantages of the present invention will become more apparent from the detailed description set forth below when read in conjunction with the drawings. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The present invention provides systems and methods to provide configurable access control security for virtualization, and applications thereof. In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Virtualization may be categorized as Type I or Type II. Type I virtualization is hardware-based hypervisor virtualization (such as Xen founded by XenSource, Inc. of Cambridge, Mass.). Type II is para-virtualization that runs on top of the kernel (such as VMware provided by VMware, Inc. of Palo Alto, Calif.). Although example details set forth herein may only apply to one of these types of virtualization, this is for illustrative purposes only, and not limitation. It is to be appreciated that the systems and methods set forth herein can be applied to both Type I and Type II virtualization, as would be apparent to a person skilled in the relevant art(s).

### II. Example System

A. Overview

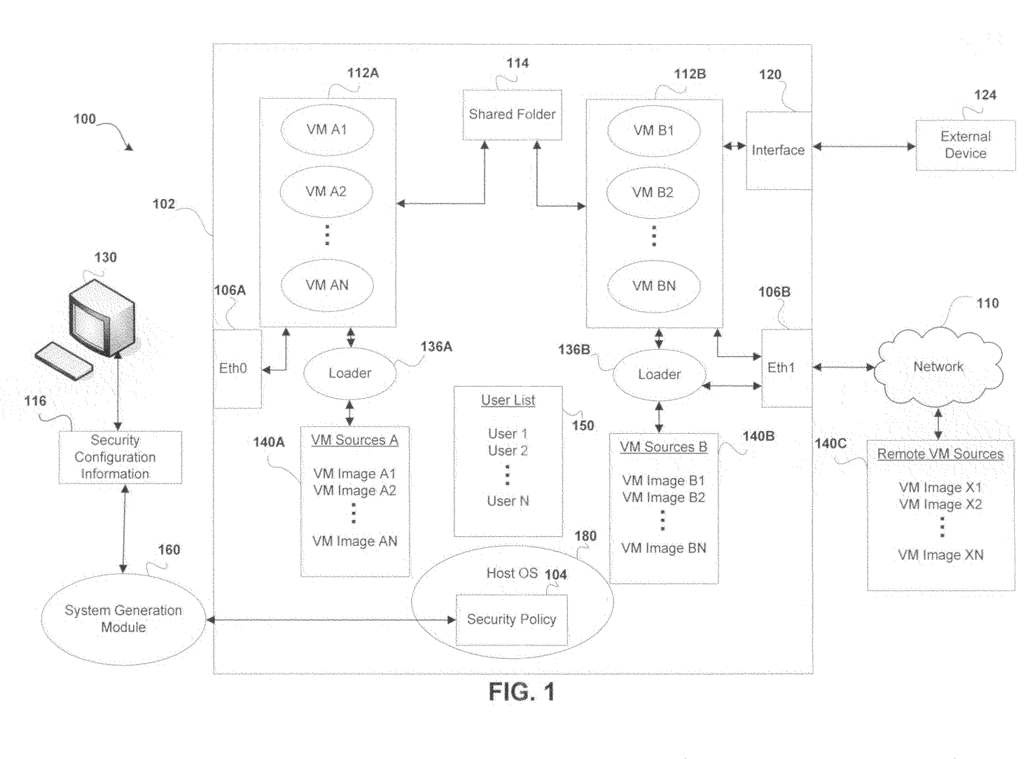

FIG. 1 illustrates an example system 100 having a security policy 104 implemented by host OS 180 running on a machine 102. In an embodiment, security policy 104 is a MAC security policy. Machine 102 includes system resources—such as a shared folder 114, a first network card 106A, a second network card 106B coupled to a network 110, and an external device interface 120 coupled to an external device 124. Machine 102 is also configured to include a first container 1 12A and a second container 112B.

Containers 112 are each configured to run one or more virtual machines. That is, containers 112 are security boundaries that may contain one or more virtual machines. For example, a loader 136A may retrieve one or more virtual machine images from a local source (namely, VM Sources A 140A), and load the one or more virtual machine images into first container 112A to run one or more virtual machines. Similarly, a loader 136B may retrieve one or more virtual machine images from a local source (namely, VM Sources B 140B) or a remote source (namely, Remote VM Sources 140C), and load the one or more virtual machine images into second container 112B to run one or more virtual machines.

Security policy 104 provides security for machine 102 based on security configuration information 116. For example, security policy 104 can control whether a virtual machine running in first container 112A or second container 112B is able to access the system resources of machine 102. Security policy 104 may be implemented, for example, as a MAC security policy in SELinux. SELinux is described in more detail, for example, in Bill McCarty, SELinux: NSA's Open Source Security Enhanced Linux (Andy Oram ed., 2005), and Frank Mayer et al., SELinux by Example (Prentice Hall, 2007), both of which are incorporated by reference herein.

B. Configurability of Security Policy

Security policy 104 may be easily configured and/or reconfigured by a system administrator. As would be known to persons skilled in the relevant art(s), a typical security policy can include upwards of 50,000 lines of source code. Reconfiguring such a security policy is difficult and time-consuming, requiring a detailed understanding of the source code and security policy. In contrast, an embodiment of the present invention provides a simplified manner for configuring and/or reconfiguring security policy 104.

According to this embodiment, the system administrator provides security configuration information 116 to system generation module 160 via display 130. For example, the system administrator may interact with a graphical user interface (GUI) provided on display 130 to provide security configuration information 116. Security configuration information 116 specifies the access profile for virtual machines running on machine 102. Based on security configuration information 116, system generation module 160 configures and/or reconfigures security policy 104.

Security configuration information 116 may specify one or more containers for machine 102, and the access rights to be granted to those containers. For example, FIG. 1 illustrates that machine 102 includes first container 112A and second container 112B. A virtual machine running in a particular container 112 inherits the access profile of that container. For example, virtual machines A1 through AN running in first container 112A inherit the access profile of first container 112A, and virtual machines B1 through BN running in second container 112B inherit the access profile of second container 112B. In this way, containers 112 allow more than one virtual machine to share the same access profile.

C. Security Policy Controls Access

The access profile of each container 112 is controlled by security policy 104. A set forth above, a system administrator can configure security policy 104 based on security configuration information 116. Thus, the system administrator can configure the access profile of each container 112 to provide for secure and flexible resource sharing between virtual machines of first container 112A and second container 112B. The access profile may include, for example, (1) the system resources that each container 112 may access, (2) the virtual machine images that may be loaded into each container 112, (3) the users that may access each container 112 and/or virtual machine images, and (4) other types of access controls and checks.

### 1. Controlled Access to System Resources

Security policy 104 may control, for example, the access that each container 112 has to system resources. In such an example, security policy 104 may be implemented as a MAC security policy. Such system resources may include, but are not limited to, a first network card 106A, a second network card 106B, a shared folder 114, and an external device interface 120 connected to an external device 124 (such as universal serial bus (USB) drives or removable storage devices (e.g., CD/DVD, floppy), etc.). As illustrated in FIG. 1, both containers 112 have access to shared folder 114. In contrast, only first container 112A has access to first network card 106A, and only second container 112B has access to second network card 106B and external device interface 120.

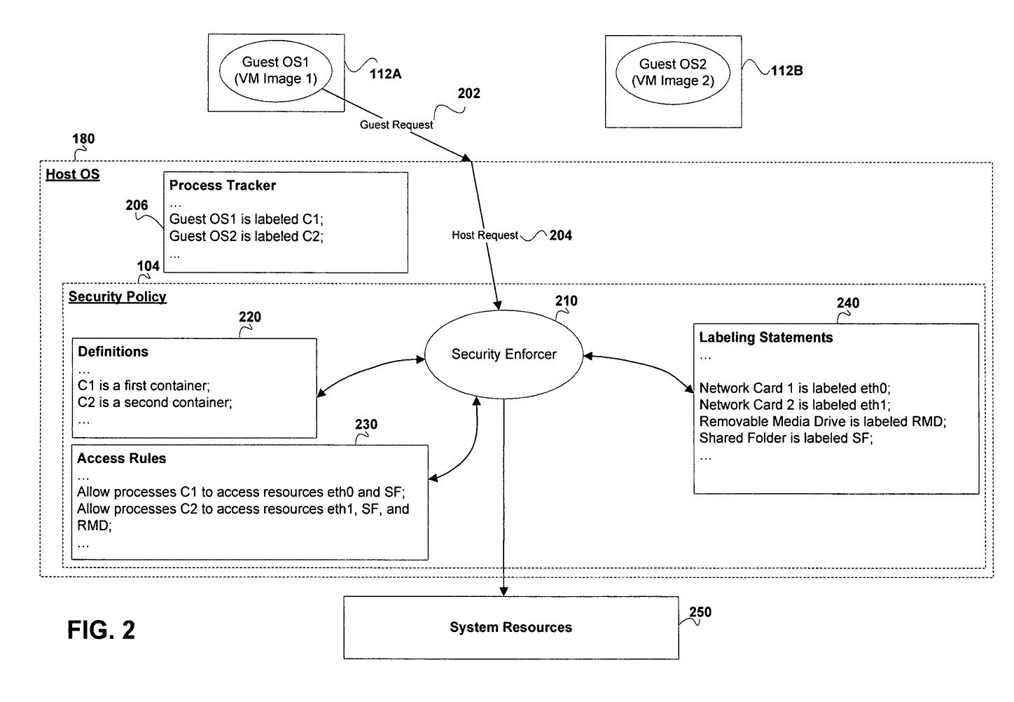

FIG. 2 illustrates an example manner in which security policy 104 controls access to system resources 250 of machine 102. As illustrated in FIG. 2, a first guest OS (such as Windows 2000 Professional provided by Microsoft, Corp. of Redmond, Wash.) runs in first container 112A and a second guest OS (such as Fedora 8) runs in second container 112B of machine 102. The first guest OS and the second guest OS can access system resources 250 through the host OS 180. For example, the first OS issues a guest request 202. Guest request 202 corresponds to resources that would be present on the native system of the first guest OS. Guest request 202 does not explicitly reference specific system resources 250.

Host OS 180 receives the guest request 202 from the first guest OS, and translates it into a host request 204. Host request 204 is a request for access to one or more specific resources included in system resources 250.

Host OS 180 includes a process tracker 206 that labels each process running on machine 102. Referring to process tracker 206 of the example in FIG. 2, the first guest OS is labeled C1 and the second guest OS is labeled C2. Accordingly, host request 204 is associated with the label C1 because host request 204 corresponds to guest request 202 from the first guest OS. In a similar manner, a host request corresponding to a guest request from the second guest OS would be associated with the label C2.

Security policy 104 controls whether the first guest OS may access system resources 250 based on the access rights granted to processes with label C1. Security policy 104 includes, for example, a security enforcer 210, definitions 220, labeling statements 240, and access rules 230. Definitions 220 define types used by security policy 104. Labeling statements 240 label each system resource with a label. Access rules 230 set forth which system resources each type may access based on the label associated with each system resource and each type. Security enforcer 210 enforces access rules 230 based on definitions 220 and labeling statements 240.

For the example of FIG. 2, definitions 220 indicate that C1 is a first container. Access rules 230 indicate that processes labeled C1 are allowed to access resources labeled eth0 and SF. Labeling statements 240 indicate that eth0 is a first network card, and SF is a shared folder. Accordingly, security enforcer 210 allows the first guest OS to access the first network card (which is indicated in FIG. 1 by a bidirectional arrow between first container 112A and first network card 106A) and the shared folder (which is indicated in FIG. 1 by a bidirectional arrow between first container 112A and shared folder 114), but does not allow it to access the second network card or the removable media drive. In a similar manner, security enforcer 210 allows the second guest OS to access the second network card (which is indicated in FIG. 1 by a bi-directional arrow between second container 112B and second network card 106B), the shared folder (which is indicated in FIG. 1 by a bi-directional arrow between second container 112B and shared folder 114), and the removable media drive (which is indicated in FIG. 1 by a bi-directional arrow between second container 112B and interface 120), but would not allow it to access the first network card.

### 2. Controlled Access to Virtual Machine Images

Security policy 104 may also control, for example, the virtual machine images that may be loaded into containers 112, thereby controlling the virtual machines that may run in containers 112. In one embodiment, a MAC security policy controls the virtual machine images that may be loaded into container 112. In another embodiment, a DAC security policy controls the virtual machine images that may be loaded into container 112.

As is well-known in the art, a virtual machine image contains (1) a snapshot of a program or OS that a virtual machine can load and execute, (2) a file defining the resources that the program or OS can access, and (3) other files for housekeeping and administrative purposes. The virtual machine images loaded into containers 112 can be loaded from a local source or from a remote source.

For example, FIG. 1 illustrates that loader 136A may only load virtual machine images from a local source. That is, only virtual machine images from VM Sources A 140A may be loaded into first container 112A. In contrast, FIG. 1 illustrates that loader 136B may load virtual machine images from either a local source or a remote source. That is, loader 136B may load virtual machine images which are retrieved locally from VM Sources B 140B and/or which are retrieve remotely over network 110 from Remote VM Sources 140C.

In an embodiment, virtual machine images are reconfigured to reflect the access profile of a container. If security policy 104 has been reconfigured to grant (or deny) a container access to a system resource, for example, then the virtual machine image is automatically reconfigured to reflect the change in access rights given to that container. In an embodiment, the virtual machines can be automatically reconfigured when added to a container at run time.

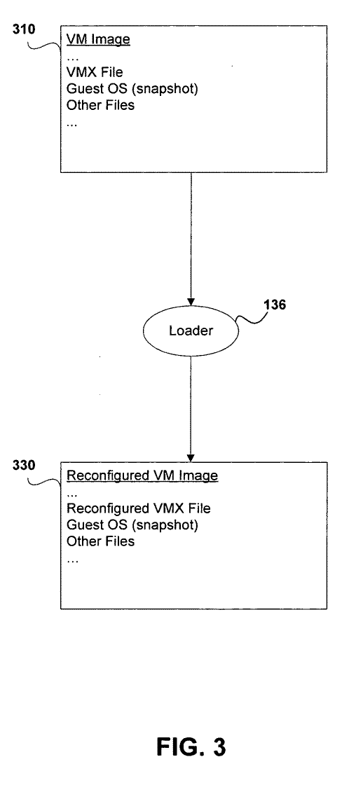

For example, FIG. 3 is a diagram illustrating an example manner in which a virtual machine image 310 is reconfigured into a reconfigured virtual machine image 330 based on a reconfiguration of security policy 104. Loader 136 may retrieve virtual machine image 310 from a local source (such as VM Sources A 140A or VM Sources B 140B of FIG. 1) or from a remote source (such as Remote VM Sources 140C of FIG. 1). Virtual machine image 310 may include, for example, a VMX file, a snapshot of a guest OS, and other files (such as administrative and housekeeping files). The VMX file specifies the resources (such as network cards, shared folders, etc.) that the virtual machine running the guest OS is able to access. The snapshot of the guest OS may correspond to different points during the operation of the guest OS. In this way, for example, different snapshots of the guest OS may be included in different virtual machine images in order to load the guest OS at different points during operation.

Access rights granted to a container 112 in which virtual machine image 310 is to be loaded may not correspond to the access specified in the VMX file of that virtual machine image. In such a case, loader 136 can reconfigure the VMX file of virtual machine image 310 to provide a reconfigured VMX file in reconfigured virtual machine image 330, wherein the reconfigured VMX file corresponds with the access rights granted to container 112. In an embodiment, loader 136 does this by comparing the VMX file of virtual machine image 310 to the access rights granted to container 112 and making any required adjustments to form the reconfigured VMX file in reconfigured virtual machine image 330.

For example, if virtual machine image 310 is to be loaded into first container 112A, the virtual machine would only be allowed to access one network card (namely, first network card 106A) because first container 112A is only allowed to access one network card. In contrast, the VMX file may indicate that the virtual machine running the guest OS is able to access two different network cards. In this example, loader 136 reconfigures the VMX file of virtual machine image 310 to indicate that this virtual machine is only allowed to access one network card. The reconfigured VMX file is included in reconfigured virtual machine image 330 provided by loader 136.

Provided below in Table 1 is an example reconfigured VMX file. Lines that have been deleted are shown in strikethrough. Lines that have been added are shown in bold, italics, and underline. For illustrative purposes, line numbers have been added to the example VMX file of Table 1.

TABLE 1
Example VMX File

| | |
|---|---|
| 00 | ... |
| 01 | annotation = “” |
| 02 | [symbol] |
| 03 | [symbol] |
| 04 | extendedconfigfile = “f8-targeted.vmxf” |
| 05 | guestos = “redhat” |
| 06 | memallowautoscaledown = “FALSE” |
| 07 | ... |
| 08 | checkpoint.vmstate = “” |
| 09 | config.version = “8” |
| 10 | ethernet0.addresstype = “generated” |
| 11 | [symbol] |
| 12 | [symbol] |
| 13 | ethernet0.generatedaddress = “00:0c:29:99:98:59” |
| 14 | ethernet0.generatedaddressoffset = “0” |
| 15 | ethernet0.present = “TRUE” |
| 16 | [symbol] |
| 17 | floppy0.present = “FALSE” |
| 18 | ide0:0.filename = “f8-targeted.vmdk” |
| 19 | ide0:0.present = “TRUE” |
| 20 | ... |
| 21 | ide1:0.devicetype = “cdrom-raw” |
| 22 | ide1:0.filename = “D:” |
| 23 | ide1:0.present = “TRUE” |
| 24 | [symbol] |
| 25 | [symbol] |
| 26 | [symbol] |
| 27 | scsi0.present = “TRUE” |
| 28 | [symbol] |
| 29 | [symbol] |
| 30 | sound.autodetect = “TRUE” |
| 31 | sound.filename = “−1” |
| 32 | [symbol] |
| 33 | [symbol] |
| 34 | sound.startconnected = “FALSE” |
| 35 | sound.virtualdev = “es1371” |
| 36 | tools.remindinstall = “TRUE” |
| 37 | tools.upgrade.policy = “manual” |
| 38 | [symbol] |
| 39 | [symbol] |
| 40 | uuid.bios = “56 4d a2 c4 c6 f2 da e3-4a 2f 6f 23 aa 99 98 |
| | 59” |
| 41 | uuid.location = “56 4d a2 c4 c6 f2 da e3-4a 2f 6f 23 aa |
| | 99 98 59” |
| 42 | virtualhw.productcompatibility = “hosted” |
| 43 | ... |

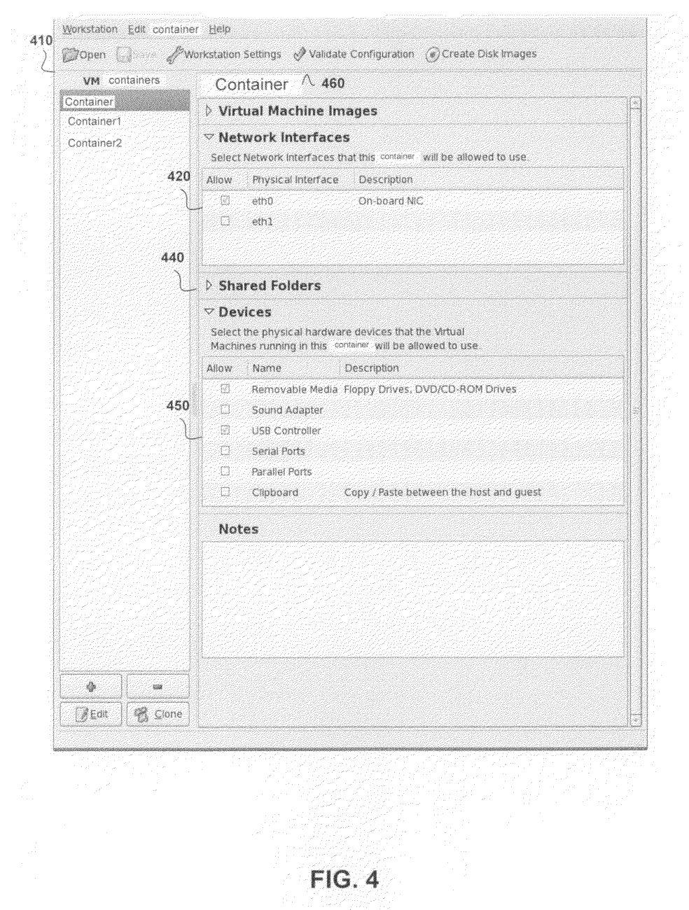

FIG. 4 is a screenshot of an example GUI 410 that may be used to provide security configuration information 116. The changes in the example VMX file of Table 1 reflect the security configuration information illustrated in GUI 410.

As illustrated in FIG. 4, the container name 460 in this example is Container. Lines 02 and 03 reflect that the guest OS name is modified to reflect the container name as well as the OS. This makes it easier for the user to determine the function associated with the guest OS.

Various changes to the VMX file will occur when the network cards are enabled or disabled. The extent of the changes will depend on the original configuration. For example, box 420 of FIG. 4 illustrates that a user has selected “Container” to have access to the network interface eth0. This selection is illustrated in lines 11 and 12 of the example VMX file of Table 1.

Various changes will occur when access to shared folders is added or removed. For example, box 440 of FIG. 4 illustrates that no shared folders are allowed. This is reflected in lines 28 and 29 of the example VMX file of Table 1.

Various changes will occur when access to the Clipboard is enabled or disabled. For example, box 450 of FIG. 4 illustrates that the user has not selected “Container” to have access to the Clipboard. This selection is reflected in lines 24-26 of the example VMX file.

Box 450 further illustrates that no sound adapters have been selected. Lines 32 and 33 of the example VMX file of Table 1 illustrate what happens when access to the sound adaptor is removed.

Box 450 further illustrates that a USB controller has been selected. Lines 38 and 39 of the example VMX file of Table 1 illustrate changes to the VMX file as a result of allowing access to the USB devices.

### 3. Controlled Access Based on User

Security policy 104 may also be configured by an administrator to restrict access to containers 112 on a per-user basis. As is well-known, machine 102 may include an authentication process, whereby one of the users included in User List 150 may log into machine 102—e.g., by typing in a username and password. After authenticating and validating the username and password, security policy 104 can restrict access to containers 112 based on the user logged into machine 102. In addition, virtual machines running in containers 112 may also be restricted to particular users.

In an embodiment, system 100 is configured as a thin client, wherein all virtual machine images are dynamically retrieved over network 110 based on the user logged into system 100. In this embodiment, a user would log into system 100 using well-known means. Based on security configuration information 116 provided by a system administrator and configured into security policy 104, the user is granted access to one or more containers. When the user is authenticated to system 100, the virtual machine image(s) appropriate for the one or more containers are loaded from remote VM source 140C over network 110. Different users may have different virtual machine images for the same container. When the user logs out, the virtual machine image(s) for that user are deleted.

### 4. Other Access Controls and Checks

Security policy 104 may also control other types of access or operations as would be apparent to a person skilled in the relevant art(s). For example, security policy 104 can be configured to restrict or to allow cut and paste operations between a first virtual machine of first container 112A and a second virtual machine of second container 112B.

Additionally, hardware verification/validation may be performed when the system is installed to validate that the hardware on the system matches the hardware expected by the security configuration. For example, the number of network cards on machine 102 can be compared to the network cards expected by the administrator, and/or it can be verified whether the network cards are connected properly. Based on this comparison and/or verification process, a notification can be presented if the number of network cards does not match the expected number of cards and/or if the network cards are not connected properly. Furthermore, the network card connections can be validated by asking the user to verify the card is connected to the proper network. This can be done manually (for example, by flashing the lights on a card and asking the user to verify that the network cables are connected to the correct card), or the check can be automated by attempting to access some known resource on each network to verify which card is utilized (i.e., ping a known server on each network).

### III. Configuration And Reconfiguration of a Security Policy

As mentioned above, security policy 104 can be modified based on security configuration information 116 provided to system generation module 160. In an embodiment, an installation package is generated based on security configuration information 116. This installation package can then be deployed to a local machine or a remote machine. In another embodiment, security policy 104 running on a local machine is reconfigured based on security configuration information 116.

### A. Generation of an Installation Package

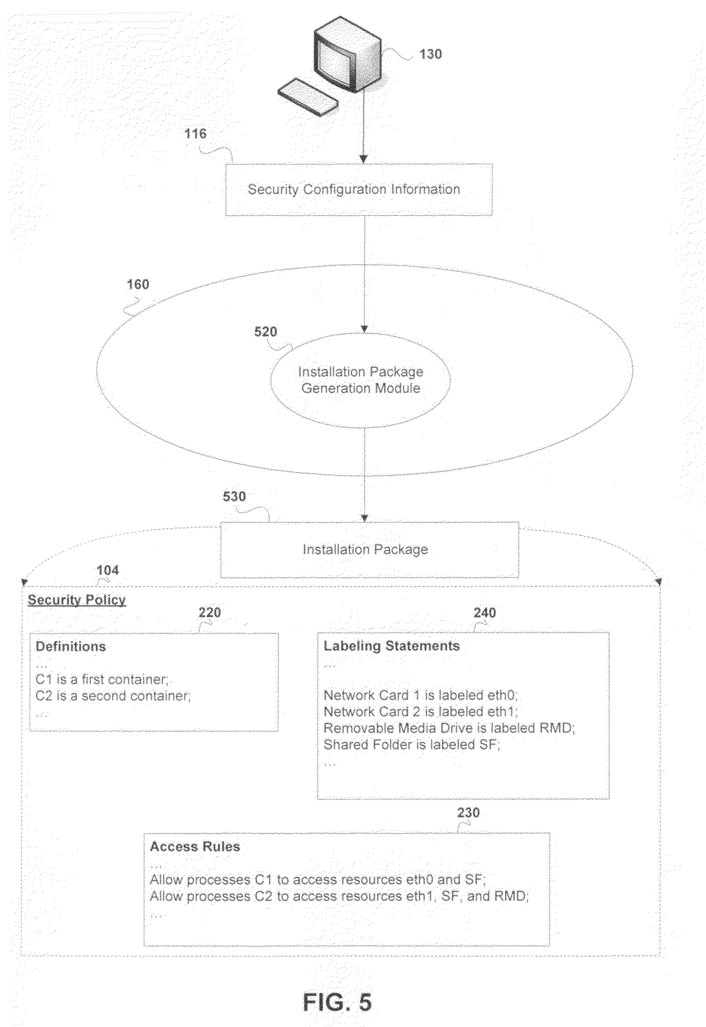

FIG. 5 is a diagram illustrating an embodiment for generating an installation package 530 for virtualization in accordance with an embodiment of the present invention. As illustrated in FIG. 5, a system administrator provides security configuration information 116. The security configuration information 116 may define, for example, a set of containers (such as containers 112 of FIG. 1). The security configuration information 116 also may define, for example, the access that each container will have to various system resources (e.g., network cards, shared folders, USB devices, etc.). The administrator can also specify that a container may be provisioned at run time by the end user from a list of virtual machine images.

Security configuration information 116 is provided to system generation module 160. As illustrated in FIG. 5, system generation module 160 may include an installation package generation module 520. Installation package generation module 520 generates an installation package 530 based on the security configuration information 116. Installation package 530 includes security policy 104, along with software needed to install a complete system (or information on how software can be obtained remotely). Installation package 530 may then be applied to a target (remote) system to install a completely configured platform.

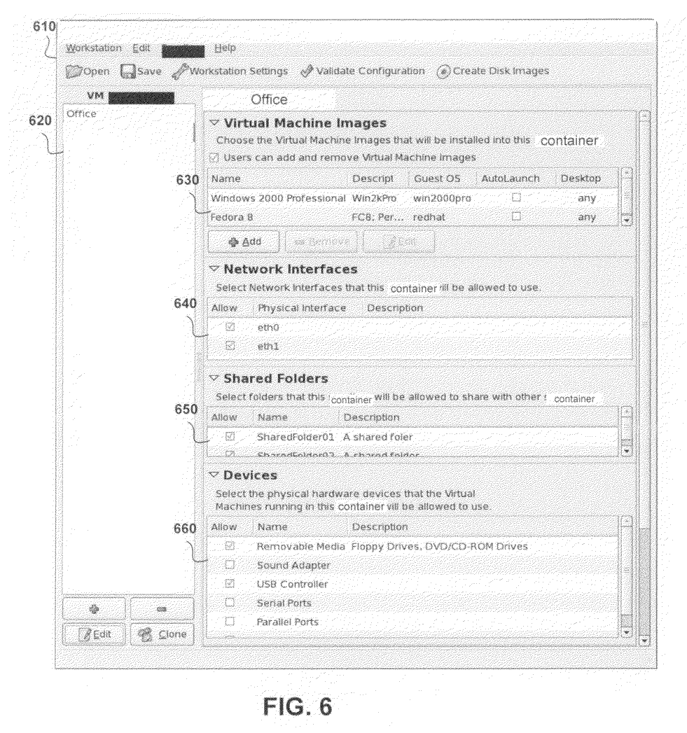

The system administrator may provide security configuration information 116 by interacting with a GUI on display 130. For example, FIG. 6 illustrates a GUI screenshot 610 that enables the system administrator to provide at least a portion of security configuration information 116. Box 620 indicates that a container, named “Office”, has been selected. Box 630 indicates that the system administrator has provided for two virtual machine images (namely, Windows 2000 Professional and Fedora 8) to be added to this container when installation package 530 is generated. These two virtual machines will have permission to access two network interfaces (namely, eth0 and eth1 as indicated in box 640), two shared folders (namely, ShareFolder01 and SharedFolder02 as indicated in box 650), and two different devices (namely, Removable Media Floppy Drives, DVD/CD-ROM Drives and USB Controller as indicated in box 660). In other words, these two virtual machines have the permissions granted to the container they are configured to be included in.

It is to be appreciated that GUI screenshot 610 is presented for illustrative purposes only, and not limitation. For example, it is to be appreciated that the system administrator can edit the access profile of other container(s) defined on the system in a similar manner to that illustrated in GUI screenshot 210. In addition, it is to be appreciated that security parameters other than the ones illustrated in GUI screenshot 610 can be modified in a similar manner to that illustrated without deviating from the spirit and scope of the present invention.

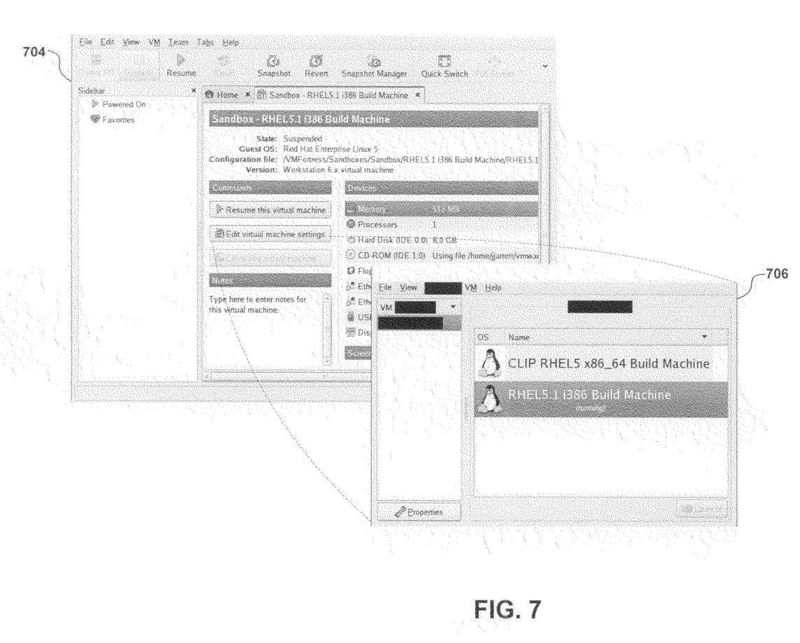

FIG. 7 illustrates a GUI screenshot 704 of a user workstation, after installation package 530 has been applied. GUI screenshot 704 reflects a different configuration than the one specified in GUI screenshot 610. Using GUI screenshot 704, the system administrator may monitor and edit the virtual machine(s) that are running or configured to run in a container. For example, the system administrator can click on the “Edit virtual machine settings” button in screenshot 704 to bring up box 706. Box 706 illustrates, for example, that a first virtual machine (CLIP RHELS x86_{—}64 Build Machine) and a second virtual machine (RHELS.1 i386 Build Machine) are configured to run in an example container, and that the second virtual machine is currently running.

B. Reconfiguration of a Security Policy

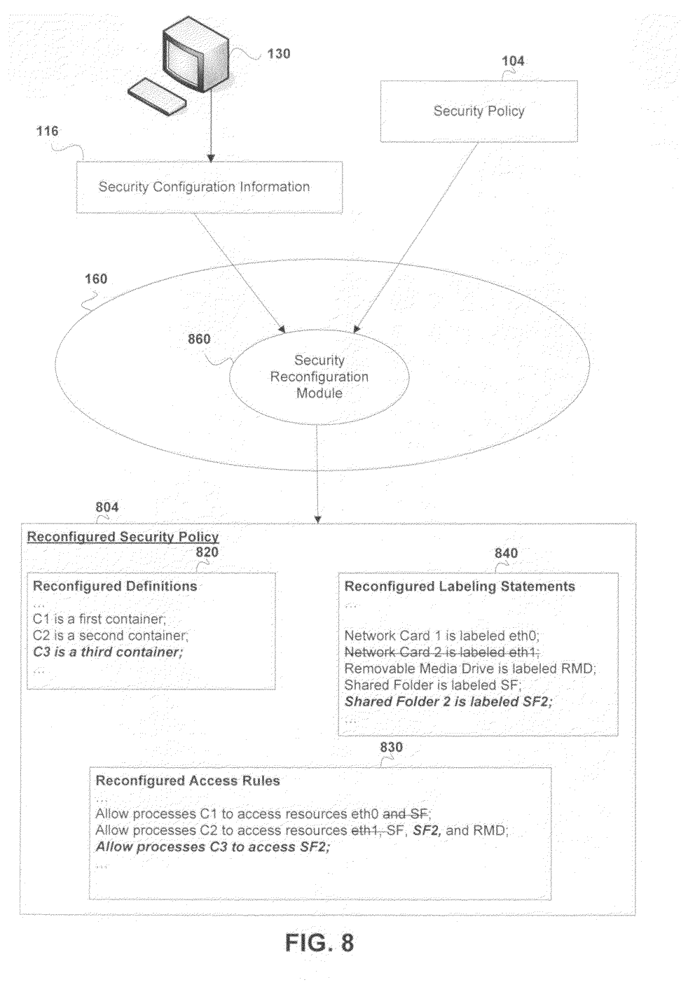

FIG. 8 is a diagram illustrating an embodiment for reconfiguring security policy 104. Similar to the embodiment depicted in FIG. 5, a system administrator provides security configuration information 116. Unlike the embodiment depicted in FIG. 5, however, security configuration information 116 in this embodiment may specify, for example, changes to be made to security policy 104.

Security configuration information 116 is provided to system generation module 160, along with security policy 104. As illustrated in FIG. 8, system generation module 160 may include a security reconfiguration module 860 that reconfigures security policy 104 based on security configuration information 116 to provide a reconfigured security policy 804.

System generation module 160 can reconfigure definitions 220, labeling statements 240, and/or access rules 230 of security policy 104 as indicated in reconfigured security policy 804. Reconfigured security policy 804 includes reconfigured definitions 820, reconfigured labeling statements 840, and reconfigured access rules 830.

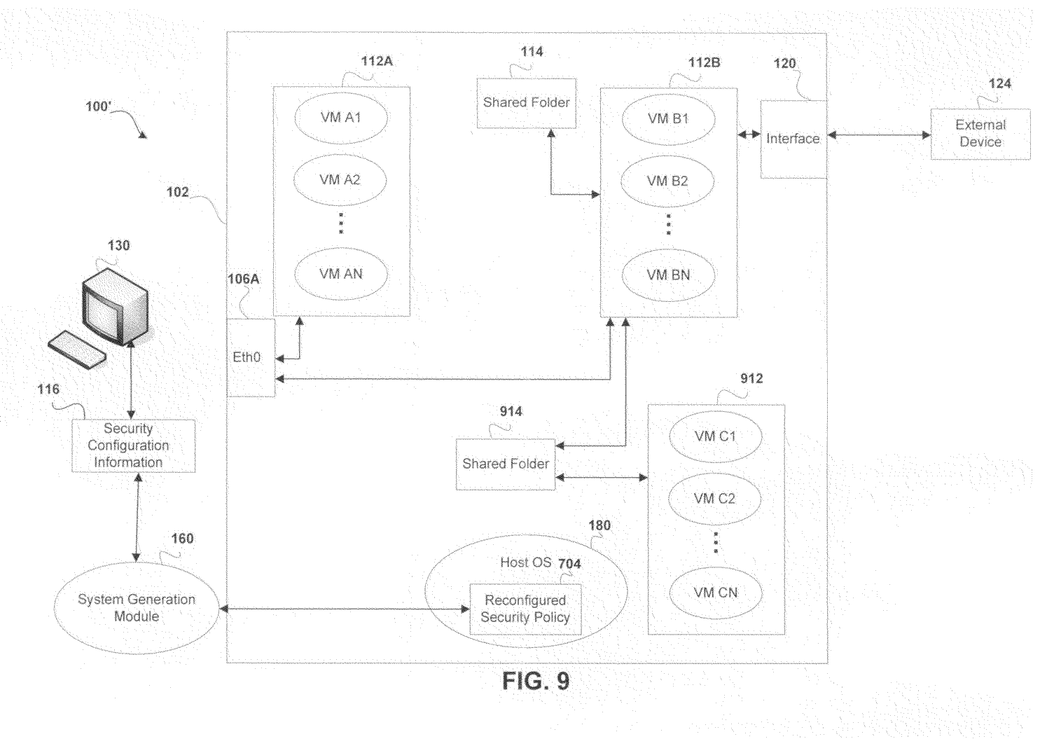

FIG. 9 is a diagram of an example system 100′ reflecting the security reconfiguration provided by reconfigured security policy 804. For example, reconfigured definitions 820 include a new definition stating that C3 is a third container (as reflected by third container 912 of FIG. 9). Reconfigured labeling statements 840 indicate that the second network card has been removed and that a second shared folder has been added (as reflected by second shared folder 914 of FIG. 9). Reconfigured access rules 830 indicate that second container 112B is no longer entitled to access second network card 106B, but is entitled to access second shared folder 914 (as reflected in FIG. 9 by the bi-directional arrow between second container 112B and second shared folder 914). Reconfigured access rules 830 also indicate that third container 912 is entitled to access second shared folder 914 (as reflected in FIG. 9 by the bidirectional arrow between third container 912 and second shared folder 914).

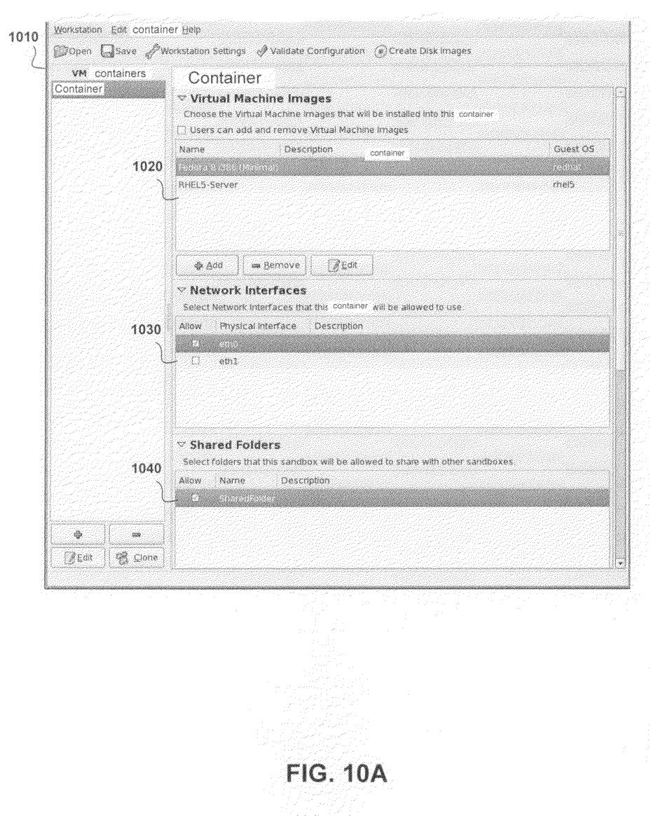

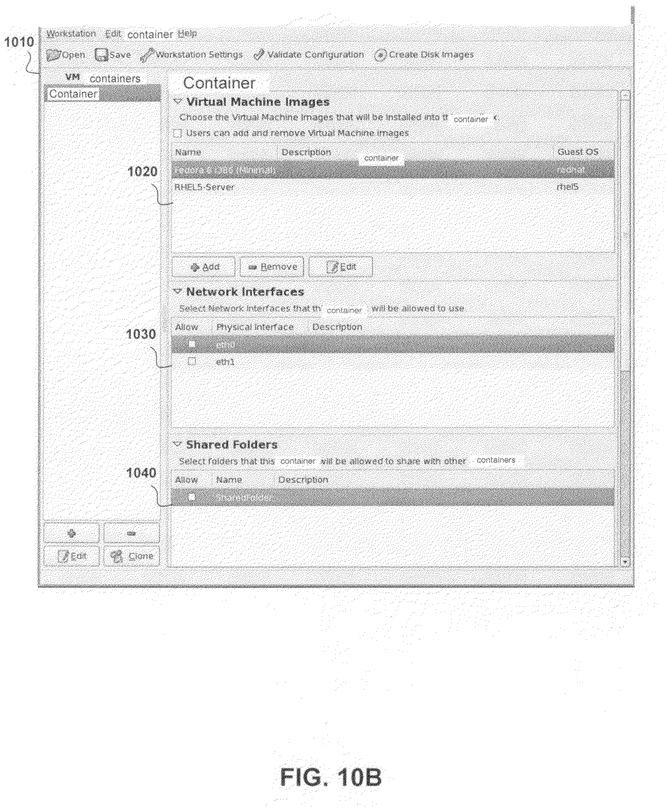

FIGS. 10A and 10B are example screenshots of a GUI 1010 that may be used to make changes to the security configuration information, and thereby reconfigure security policy 104. GUI 1010 of FIG. 10A illustrates that the container (named “Container”) is configured to run two different guest operating systems—a first guest OS Fedora 8 i386 and a second guest OS RHEL5-Server. Box 1020 of FIG. 10A illustrates that the first guest OS (Fedora 8 i386) has been selected to be edited. Box 1030 of FIG. 10A illustrates that eth0 has been selected, and box 1040 of FIG. 10A illustrates that the shared folder has been selected. Based on these selections, the two guest operating systems running in this container will be granted access to eth0 and the shared folder.

FIG. 10B illustrates changes to the security configuration information of the container that the two guest operating systems run in. For example, box 1030 of FIG. 10B illustrates that eth0 is no longer selected, and box 1040 of FIG. 10B illustrates that the shared folder is no longer selected. In other words, a user has changed the security configuration information in order to change the access profile of this container.

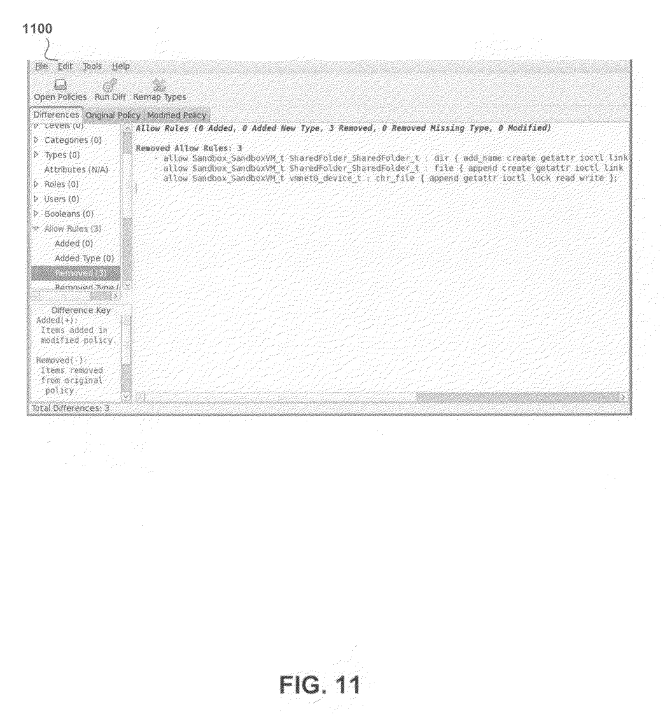

FIG. 11 is a screenshot of an example GUI 1100. GUI 1100 illustrates changes to the security policy that occur based on the changes in the security configuration information reflected in GUI 1010 of FIGS. 10A and 10B.

It is to be appreciated that these changes are presented for illustrative purposes only, and not limitation. Other types of changes to the security configuration information can be provided, and thereby other changes to the security policy can be made, without deviating from the spirit and scope of the present invention, as would be apparent to a person skilled in the relevant art(s).

### IV. Summary

Various systems and methods for implementing configurable access control security for virtualization in a computer, and applications thereof, have been described in detail herein. It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way. Furthermore, although aspects of the present invention have been described with reference to SELinux, the invention is not limited to the Linux operating system or SELinux. Based on the description contained herein, a person skilled in the relevant art(s) will appreciate that embodiments of the present invention can be implemented with regard to other operating systems.

What is claimed is:

1. A system to provide security for a computer, comprising:
one or more containers configured to contain one or more virtual machines;
a plurality of virtual machine images;
a configurable security policy that controls access to the one or more containers and controls system resources available to the one or more containers;
a loader that loads a first virtual machine image into a first container based on the access granted by the configurable security policy; and
a user interface configured to receive security configuration information, wherein the configurable security policy is configurable based on the security configuration information.

2. The system of claim 1, wherein the access to the system resources granted to the first container is not changed when the first virtual machine image is loaded into the first container.

3. The system of claim 1, wherein the configurable security policy controls which of the one or more virtual machines can be included in the container.

4. The system of claim 1, wherein the configurable security policy comprises a mandatory access control security policy.

5. The system of claim 1, wherein the loader reconfigures the first virtual machine image to correspond to the access granted to the first container by the configurable security policy.

6. The system of claim 1, wherein the first virtual machine image is received from a remote source over a network.

7. The system of claim 1, wherein the configurable security policy controls access to the one or more containers on a per-user basis, such that a first user can access a first set of containers and a second user cannot access the first set of containers.

8. The system of claim 7, wherein the first virtual machine image is retrieved from a remote source over a network based on a user logged into the system.

9. The system of claim 7, wherein the first virtual machine image is retrieved from a local source based on a user logged into the system.

10. The system of claim 1, wherein the loader is configured to load the first virtual machine image into the first container based on the access granted by the configurable security policy and based on a user logged into the system, such that a first user can use the first virtual machine image and a second user cannot use the first virtual machine image.

11. The system of claim 10, wherein the first virtual machine image is received from a remote source over a network.

12. A computer-implemented method to provide security for a computer, comprising:
receiving security-configuration information via a user interface, wherein the security-configuration information defines one or more containers and a plurality of system resources, and wherein the one or more containers are configured to include one or more virtual machines;
controlling, with a security policy, which system resources that each container is entitled to access, wherein the security policy is configurable based on the security-configuration information; and
loading a first virtual machine image into a first container based on access granted to the first container by the security policy.

13. The computer-implemented method of claim 12, wherein the loading comprises:
loading the first virtual machine image into the first container based on the access granted to the first container by the security policy, wherein the access granted to the first container is not changed when the first virtual machine is loaded into the first container.

14. The computer-implemented method of claim 12, wherein the loading comprises:
loading the first virtual machine image into the first container based on the access granted to the first container by the security policy, wherein the security policy controls which of the one or more virtual machines can be included in the first container.

15. The computer-implemented method of claim 12, wherein the loading comprises:
loading the first virtual machine image into the first container based on the access granted to the first container by a mandatory access control security policy.

16. The computer-implemented method of claim 12, further comprising:
reconfiguring the first virtual machine image to correspond to the access granted to the first container by the security policy.

17. The computer-implemented method of claim 12, further comprising:
receiving the first virtual machine image from a remote source over a network.

18. The computer-implemented method of claim 12, further comprising:
controlling, with the security policy, access to the one or more containers on a per-user basis, such that a first user can access a first subset of the one or more containers and a second user can access a second subset of the one or more containers.

19. The computer-implemented method of claim 18, further comprising:
retrieving the first virtual machine image from a remote source over a network based on a user logged into a computer system.

20. The computer-implemented method of claim 18, further comprising:
retrieving the first virtual machine image from a local source based on a user logged into a computer system.

21. The computer-implemented method of claim 12, wherein the loading comprises:
loading the first virtual machine image into the first container based on the access granted to the first container by the security policy and based on a user logged into a computer system, such that a first user can use the first virtual machine image and a second user cannot use the first virtual machine image.

22. The computer-implemented method of claim 21, further comprising:
receiving the first virtual machine image from a remote source over a network.

23. A computer-implemented method for configuring mandatory access control (MAC) security, comprising:
(a) receiving security-configuration information that defines a security profile for one or more containers and a plurality of system resources, wherein the one or more containers are configured to include one or more virtual machines; and
(b) implementing a MAC security policy based on the security-configuration information.

24. The computer-implemented method of claim 23, wherein step (b) comprises:
(b1) generating a MAC security installation package based on the security-configuration information; and
(b2) deploying the installation package to a remote machine.

25. The computer-implemented method of claim 23, wherein step (b) comprises:
(b1) reconfiguring a MAC security policy of a local machine based on the security-configuration information.
